(19) United States
(12) Patent Application Publication
(10) Pub. No.: US 2013/0313451 A1
(43) Pub. Date: Nov. 28, 2013

(54) DIAPHRAGM ACTUATOR

(71) Applicant: Terry Glenn Young, Longview, TX (US)

(72) Inventor: Terry Glenn Young, Longview, TX (US)

(73) Assignee: Array Holdings, Inc., Houston, TX (US)

(21) Appl. No.: 13/478,558

(22) Filed: May 23, 2012

(51) Int. Cl. F16K 31/126

(52) U.S. Cl. 251/61.4

(57) ABSTRACT

A valve actuator apparatus having improved diaphragm retention to protect against tensile loading and ability to adjust the top shaft diameter within said actuator.

### FIELD

The present invention relates generally to valve actuators. More particularly the present invention relates to a valve actuator having improved diaphragm retention to protect against tensile loading.

### BACKGROUND

A valve is a device that regulates the flow of a substance. Valves are produced in a variety of different styles, shapes and sizes. Typically, valves are used for gases and liquids. However, valves are also used on solids capable of flow, slurries or any other substance capable of flow. Valves are used in almost every industry having a substance that flows.

One type of valve is a gate valve, also referred to as a sluice valve. A gate valve opens by moving a blocking element from the path of flow. The blocking element may be a round disk, a rectangular element, or a wedge. Gate valves have a blocking element and a seat forming a substantially leak proof seal. In a gate valve, the blocking element can be referred to as a gate valve block, a gate block or a block. In the open position, a gate valve has a bore where the substance is allowed to partially or completely flow through the valve. In a gate valve, the bore may be referred to a gate valve bore. When the gate valve bore is across the valve bore the gate valve is in an open position. When the gate valve block is across the valve bore, the gate valve is in a closed position.

Gate valves may be operated manually or automatically. One method to automatically operate a gate valve is to use an actuator. An actuator is a mechanical device for moving or controlling a mechanism or system. When an actuator is used in a gate valve, the actuator is typically linked to a stem to repeatedly move the valve gate between open and closed positions.

Actuators to open and close the gate valves may include manual operators, diaphragm-type operators, pneumatic operators and hydraulic operators. Often, a manual operator is combined with a manual operator with a diaphragm-type, pneumatic or hydraulic operator for back-up and test purposes. Additionally, the actuator may include a bonnet assembly, which interconnects the valve body and the valve gate, and a bonnet stem which is movable with the gate via an operator.

Diaphragm actuators are popular for use with valves due to dependability. These actuators generally have a housing containing a diaphragm, an operator stem and one or more springs. The operator stem may include a joined top stem in some designs, while in other designs; the top stem and operator stem are separate. In general, an end portion of the top stem passes through the central hole or aperture of the diaphragm in such actuators. Generally, a diaphragm retaining nut with a central aperture will be slid down the top stem such that the diaphragm retaining nut presses against and retains the diaphragm against a diaphragm retainer plate. Thus in such designs the diaphragm retaining nut and the diaphragm retainer plate sandwich the diaphragm. In this case, the movement of the diaphragm due to pressurization of one chamber of the diaphragm actuator housing will cause corresponding movement of the top stem. Typically, the diaphragm aperture is sealed to prevent pressure loss between the upper housing and the lower housing. Techniques known in the art to seal the diaphragm aperture include seals, washers, O-rings and the like.

In certain instances, such as due to the pressurization of the upper chamber of a diaphragm actuator, the diaphragm is pulled or subject to increased tensile loading. Such stresses can lead to a leak in the diaphragm causing an unwanted depressurization. Also, such unwanted depressurization may lead to valve closure when unwanted.

A need exists for a diaphragm valve actuator which have at least one moveable diaphragms to control a fluid flow and are commonly used for processing high pressure fluids over 170 psi.

A major disadvantage with valve actuators with diaphragms is that the diaphragms wear out and require periodic replacement. The diaphragm is typically a flexible material sandwiched between a top and bottom diaphragm housing fastened together by tightening several fasteners. A problem arises in that the flexible diaphragms offer little resistance to forces exerted on the diaphragm as the fasteners are tightened. During assembly of a diaphragm valve, there is a tendency to over-tighten the fasteners in an effort to assure leak-proof junctions. Over-tightening of the fasteners causes over-compression of the diaphragm, which often results in rupture and early failure of the diaphragm.

It would be beneficial to have a valve actuator with a moveable diaphragm clamped between top and bottom diaphragm housing with one or more structures that provide circumferential sealing between the top and bottom housing, and also prevent over-compression of the flexible diaphragm.

A more secure diaphragm and diaphragm retaining device on a valve actuator may be desirable to overcome these obstacles.

### SUMMARY

Certain embodiments of the invention pertain to a valve actuator with a top actuator housing connected to a lower actuator housing, for moving a valve gate, wherein the valve actuator moves the valve gate between an opened and a closed valve position within a valve body. Still further, in such embodiments, the valve actuator may comprise a pressure chamber and an inlet port formed in the top actuator housing.

In some embodiments, the valve actuator further comprises a top shaft with a top shaft flange, wherein the top shaft extends through the top actuator housing.

In such embodiments as described above, a diaphragm retainer plate may support the top shaft within the top actuator housing. In such embodiments, the diaphragm applies pressure against the diaphragm retainer plate. In this instance, the diaphragm further comprises a pressure side that engages the diaphragm retainer plate, and an atmospheric side opposite the pressure side.

In still further embodiments regarding the diaphragm, the diaphragm has a diaphragm ridge at least partially surrounding the top shaft;

In further embodiments, the diaphragm is retained via the use of a diaphragm retainer nut with a diaphragm retainer nut circular groove at least partially surrounding the top shaft. In such embodiments, a keeper ring may be disposed around and supported by the top shaft flange, while a retainer ring may be disposed between the keeper ring and the diaphragm retainer nut.

In these embodiments of a valve actuator, the diaphragm retainer nut groove may be adapted to receive the diaphragm ridge.

In certain further embodiments the diaphragm retainer nut is positioned substantially on the pressure side of the diaphragm and possesses a threaded interface at least partially surrounding the top shaft; the threaded interface being positioned on the atmospheric side of the diaphragm and threading into a diaphragm retainer plate nut to secure the diaphragm between the diaphragm retainer nut and the diaphragm retainer plate.

Additionally, in certain embodiments, upon threading the threaded interface of the diaphragm retainer nut into the diaphragm retainer plate nut, the diaphragm ridge is positioned within the diaphragm retainer nut circular groove.

In embodiments concerning the diaphragm retainer nut wherein the diaphragm retainer nut has an inner diameter at least partially surrounding the top shaft and further comprises a sealing component spaced between the inner diameter of the diaphragm retainer nut and the top shaft.

Regarding the sealing component of the valve actuator, in certain embodiments, the sealing component comprises at least one o-ring.

Regarding the pressure chamber of the valve actuator, in certain embodiments, the pressure chamber is a pneumatic pressure chamber.

Regarding the diaphragm of the valve actuator, in certain embodiments, the diaphragm ridge is made of stainless steel and molded to the diaphragm.

Other embodiments of pertain to a diaphragm actuator with a top actuator housing connected to a lower actuator housing for moving a valve gate, and wherein the diaphragm actuator comprises: a pressure chamber and an inlet port formed in the top actuator housing; a top shaft with a top shaft flange, wherein the top shaft extends through the top actuator housing; a diaphragm retainer plate supporting the top shaft within the top diaphragm housing; a diaphragm that applies pressure against the diaphragm retainer plate, and wherein the diaphragm further comprising a pressure side that engages the diaphragm retainer plate, and an atmospheric side opposite the pressure side; a retainer housing attached to the diaphragm; a lip seal disposed within the retainer housing and at least partially surrounding the top shaft; and a seal and rod wiper combination within the retainer housing and at least partially surrounding the top shaft.

In certain embodiments of the diaphragm actuator, the diaphragm is laminated with nylon on the atmospheric side. In certain further embodiments, the the diaphragm is molded to the retainer housing.

Regarding the retainer housing of the diaphragm actuator, in certain embodiments, the top shaft diameter can be varied depending on loading and stress conditions on the top shaft. In such embodiments, the retainer housing is adapted to have variable inner diameters to match out diameters of the top shaft. Still further the retainer housing may be a two part retainer housing comprising an outer retainer housing and an inner retainer housing, the inner retainer housing being adjacent to the top shaft. Still further, the inner retainer housing may be capable of being replaced with another inner retainer housing greater or lesser in width.

In further embodiments of the diaphragm actuator, the diaphragm actuator further comprises a seal between the outer retainer housing and the inner retainer housing. In further embodiments pertaining to seals, the diaphragm actuator may comprise at one least sealing groove disposed in the retainer housing for supporting at least one seal. In additional embodiments pertaining to seals, the diaphragm actuator may comprise at least one sealing groove disposed within the top shaft for supporting at least one seal. In still further embodiments pertaining to seals, the diaphragm actuator further comprises a third sealing groove with a third seal between the retainer housing and the diaphragm retainer plate.

In many embodiments of the invention relating to the retainer housing, the retainer housing is made of stainless steel, or other strong and durable metal.

In other embodiments of the invention pertaining to a diaphragm actuator, the the pressure chamber is a pneumatic pressure chamber.

### BRIEF DESCRIPTION OF THE DRAWINGS

FIG. 1 is a cross sectional illustration of a diaphragm-type valve actuator in accord with the present invention.

FIG. 2 is a cross sectional illustration of a diaphragm retainer nut and diaphragm ridge in an alternative embodiment.

FIG. 3 is a cross sectional illustration which does not employ the raised diaphragm ridge, but instead wherein at least one lip seal is disposed in a retainer housing.

FIG. 4 is a cross sectional illustration of an embodiment which employs a first sealing groove and a second sealing groove on the interior portion of the retainer housing.

FIG. 5 is a cross sectional illustration of an embodiment having four sealing grooves disposed in a two part retainer housing.

FIG. 6 is a cross sectional illustration of an embodiment, wherein the top shaft possesses the distal sealing groove and the proximal sealing groove, rather than a portion of the retainer housing.

### LIST OF REFERENCE NUMERALS

10 diaphragm actuator

20 top actuator housing

30 lower actuator housing

40 actuator bolts

50 inlet port

53 exit port

70 upper plug

80 top shaft

83 diaphragm

85 top shaft flange

87 diaphragm ridge

89 diaphragm retainer nut groove

90 seal retainer

100 seal

110 top shaft seal

120 wear bearings

130 diaphragm retainer nut

132 retainer nut o-ring

134 diaphragm retainer plate nut

136 diaphragm retainer plate bore

137 threaded interface

138 keeper ring

139 retainer ring

140 sealing component

190 diaphragm retainer plate

191 downstop peg

192 downstop

194 downstop partial bore

195 downstop interior threading

197 operator shaft threaded stem

204 spring retainer plate

205 lip seal

206 retainer housing

207 seal and rod wiper combination

208 first sealing groove

209 second sealing groove

210 first sealing ring

211 second sealing ring

212 third sealing groove

214 retainer housing serration

215a, 215b two part retainer housing

216 distal sealing groove

217 proximal sealing groove

218 distal seal

219 proximal seal

220 exterior sealing groove

221 exterior seal

300 central spring

### DETAILED DESCRIPTION

Introduction

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings making apparent to those skilled in the art how the several forms of the invention may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3rd Edition.

Distal, in certain instances, can be defined as toward the top of the actuator and away from any valve on which the actuator rests.

Proximal, in certain instances, can be defined as toward a valve on which an actuator is mounted and away from the top of the actuator.

The present embodiments relate to a valve actuator for moving a valve gate connected to a top and bottom diaphragm housing that can move the valve gate between an open and a closed positions within a valve body. The novel valve actuator has few moving parts.

The valve actuators can be used with either direct acting gates or with a reverse acting gate. It should be noted that the top diaphragm housing can be connected to a stem which engages a valve body.

The invention also pertains to a highly reliable valve actuator that can be repaired in the field without the need for special training of a mechanic or field hand.

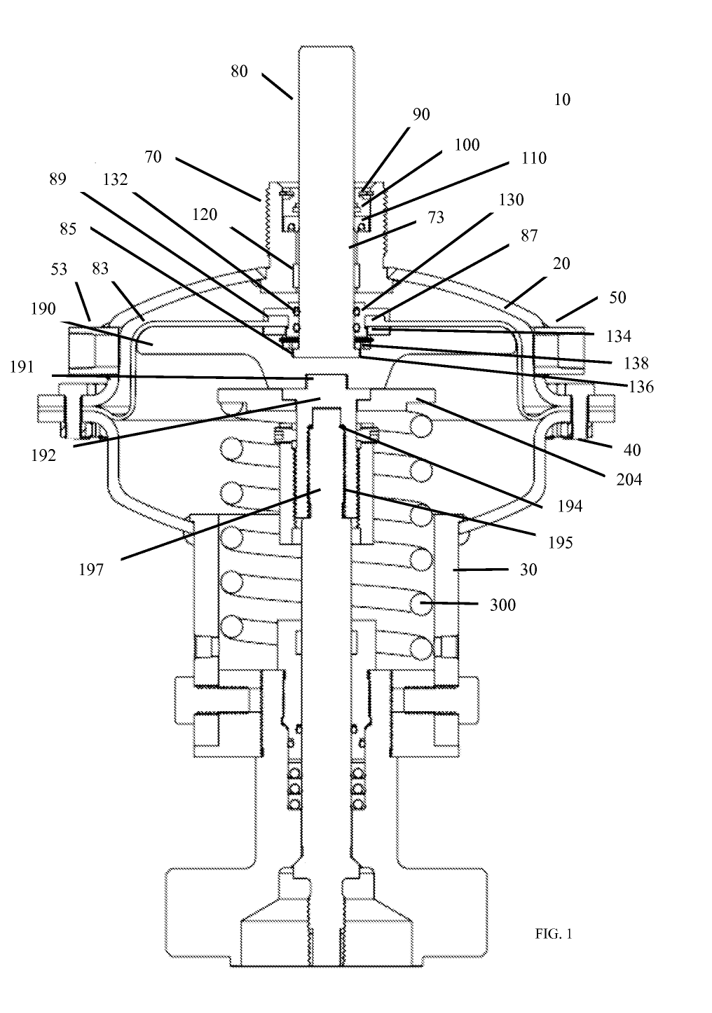

Referring now to the drawings, and more particularly to FIG. 1, a diaphragm actuator 10 is shown in the present invention. For the purposes of this description, the term distal may refer to a direction away from a valve and may refer to a direction toward a valve. Still referring to FIG. 1, the actuator has a top actuator housing 20 and a lower actuator housing 30. The top actuator housing 20 is distal to the lower actuator housing 30 and is bolted to the distal end of the lower actuator housing via a series of actuator bolts 40. Typically the bolts are oriented in a longitudinal direction. A typical lower actuator housing can be between 10 inches to about 30 inches in diameter. The shape is generally torospherical and can be made from steel with about ¼ inch to about ½ inch thickness.

The diaphragm actuator 10 can move a gate valve between an opened and a closed position within a gate valve body. Gate valves can be cast or forged. A bonnet, which is the industry description for the fastened together top and bottom diaphragm housings, can be the type that can support working pressures from about 2000 psi to about 20,000 psi.

Further in FIG. 1, the top actuator housing 20 has a port for increasing or decreasing pressure hereafter referred to as an inlet port 50. Likewise, the top actuator housing 20 has an exit port 53, which may be fitted with a pressure release valve. Thus the top actuator housing defines a pressure chamber. The pressure chamber can be adapted to support pressures between about 50 psi to about 500 psi. The pressure source may be any pressure source; exemplary pressure sources include a hydraulic pressure source or a pneumatic pressure source.

The distal end of the top actuator housing 20 possesses an upper plug 70 which is welded, cast, forged or screwed into the top actuator housing. The upper plug 70 has an internal bore for receiving a top shaft 80. Between the inner bore of the upper plug and the top shaft 80 is a seal retainer 90, preferably made of a hard substance such as stainless steel. Proximal to the seal retainer 90 is at least one seal 100. Proximal to the seal retainer and seal is a top shaft seal 110 which may comprise Polypack™. Proximal to the top shaft seal are wear bearings 120 which at least partially surround the top shaft 80. The seal retainer 90, the seal 100 and the wear bearings 120 are preferably non-metallic to eliminate close tolerance problems which may be associated with the actuator top shaft. These components may be made of hard plastic like materials such as delrin, nylon, thermoplastics, resins, polyurethanes, phenolics, acetals, polyacrylates, epoxides, polycarbonates, polyester, aramids and the like.

As further illustrated in FIG. 1, the upper plug 70, through which the top shaft 80 fits, is at the distal end of the top actuator housing 20. With positional reference to the diaphragm 83, the top shaft 80 has a distal end pointed away from the diaphragm 83 and a proximal end pointed towards the diaphragm 83. While it is contemplated that the top shaft 80 may be made of any rigid material, the top shaft 80 is preferably formed from stainless steel. Additionally, it is preferable, that the top shaft is large enough in diameter to prevent bucking stresses when loaded by a manual override or a hydraulic override. The proximal end of the top shaft passes through the diaphragm retainer nut 130 and interacts with the diaphragm retainer plate 190.

As illustrated in FIG. 1, in one embodiment the diaphragm retainer nut 130 has at least one retainer nut o-ring 132 spaced between the inner diameter of the diaphragm retainer nut 130 and the top shaft 80. Preferably, the diaphragm retainer nut 130, in this embodiment has more than one o-ring, such as two o-rings or more.

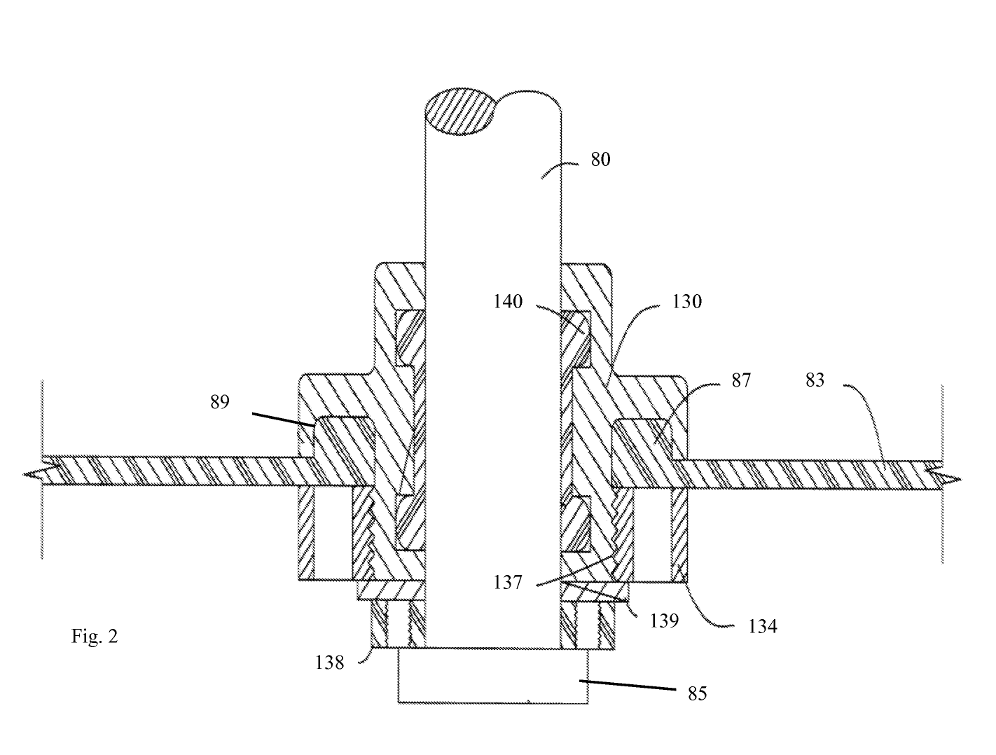

As illustrated in FIG. 2, in an alternative embodiment, the diaphragm retainer nut 130 has a sealing component 140 which surrounds the top shaft 80 and is in between the top shaft and the diaphragm retainer nut 130. The sealing component 140 can prevent pressure change from the pressurized chamber of the top actuator housing 20 to the lower actuator housing 30. The sealing component may be made of any component capable of performing this function. In exemplary embodiments, the sealing component may be made of the same material as the diaphragm 83.

More particularly illustrated in either FIG. 1 or FIG. 2, the proximal end of the top shaft 80 possesses a flange 85. The diaphragm retainer nut 130 has a threaded interface 137 near its proximal end which and threads into a diaphragm retainer plate nut 134, which is at the distal end of the partial diaphragm retainer plate bore 136. Still further, to secure the top shaft flange 85, a keeper ring 138 is employed which rests distal to the top shaft flange 85. The keeper ring 138 may be proximal to a retainer ring 139, which is spaced between the diaphragm retainer nut 130 and the keeper ring 139.

Typically, the top shaft 80 does not rotate. With this design, manual overrides or hydraulic overrides will not provide the torque requirements that injure parts of the valve actuator. Furthermore, the top shaft 80 can generally be large enough in diameter to prevent buckling under stresses when loaded by a manual override or hydraulic overrides. Typically, such a diameter of the top shaft will be between 1 and three inches with a top shaft length of between 6 and 30 inches. As the top shaft 80 protrudes from the upper plug 70, the top shaft 80 can extend from the upper plug 70 to indicate whether a valve gate is in the open or closed position.

Still further as illustrated in FIG. 1, the diaphragm 83 possesses a raised diaphragm ridge 87 surrounding the top shaft 80. In implementation, the diaphragm ridge 87 is retained by the diaphragm retainer nut groove 89 of the diaphragm retainer nut 130. This interaction prevents any pulling away of the diaphragm from the diaphragm retainer nut and alleviates the need for additional securing mechanisms to secure the diaphragm 83 to the diaphragm retainer plate 190. The diaphragm retainer nut 130 can be bonded, in an embodiment, to the flexible diaphragm 83. However, this bonding may not be required. The diaphragm retainer nut 130 can be made from a hard metal such as a stainless steel. The dimensions of the diaphragm retainer nut 130 can be between about 1.75 inches to about 4 inches.

The diaphragm can be formed from stainless steel and homogeneous type rubber supported by a nylon cloth bonded to the rubber. The nylon can prevent tension movement of the homogeneous portion of the diaphragm. Additionally, the nylon can prevent deformation of the diaphragm geometry. Diaphragms used herein can be generally round in shape. In certain embodiments, stainless steel or a metal may not be used in construction of the diaphragm itself. Preferably, the diaphragm 83 is made of nitrile laminated with several layers of nylon. Layers of nylon have an advantage of experiencing less wear from friction.

In practice, the diaphragm ridge 87 may also be made of nitrile with several layers of nylon. Alternatively, the diaphragm ridge 87 may be made of a substantially rigid substance such as a plastic, a ceramic or a metal which is molded into or otherwise permanently affixed to the diaphragm. The diaphragm ridge 87 may be of any height and of any shape so long as the ridge is able to be received by the diaphragm retainer nut groove 89.

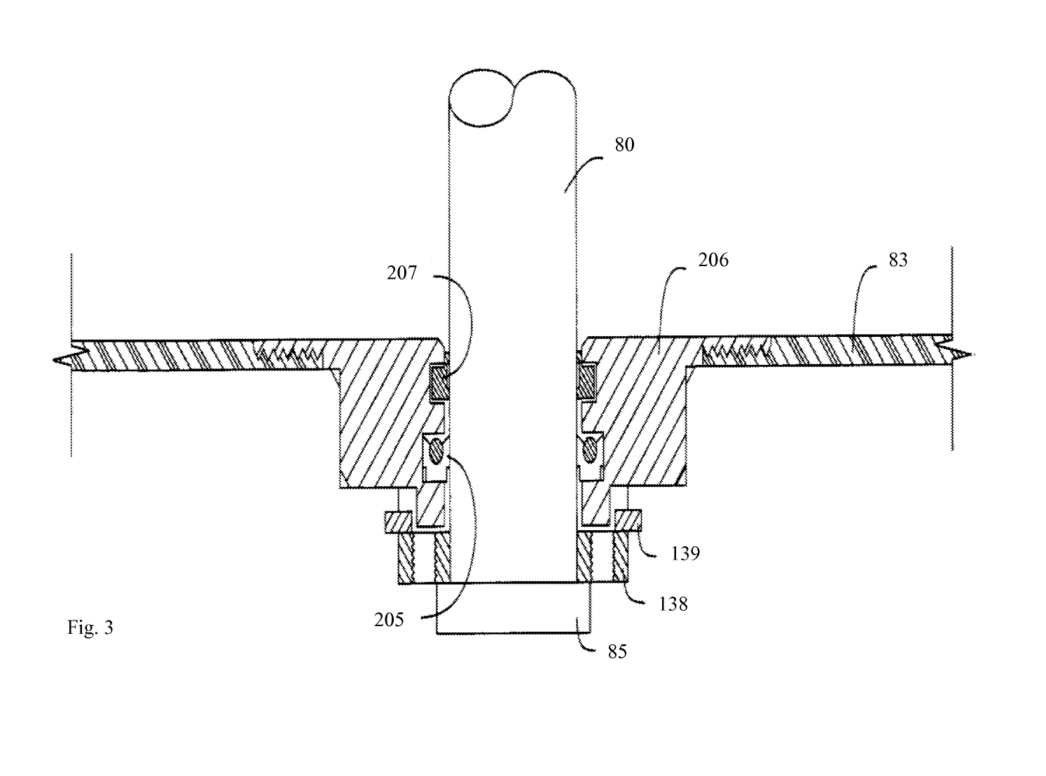

FIG. 3 is an alternative embodiment which does not employ the raised diaphragm ridge as embodiment of the invention, but instead wherein at least one lip seal 205 is disposed in a retainer housing 206. The top shaft 80 additionally can have a seal and rod wiper combination 207 disposed within the retainer housing 206. The top shaft 80 is depicted with a laminated flexible diaphragm 83, retainer housing 206, a keeper ring 138, a retainer ring 139 and a top shaft flange 85. In this embodiment, the retainer housing may be made of steel for example and is typically molded to the diaphragm. Proximal to the retainer housing 206 and distal to the top shaft flange are the keeper ring 138 and retainer ring 139.

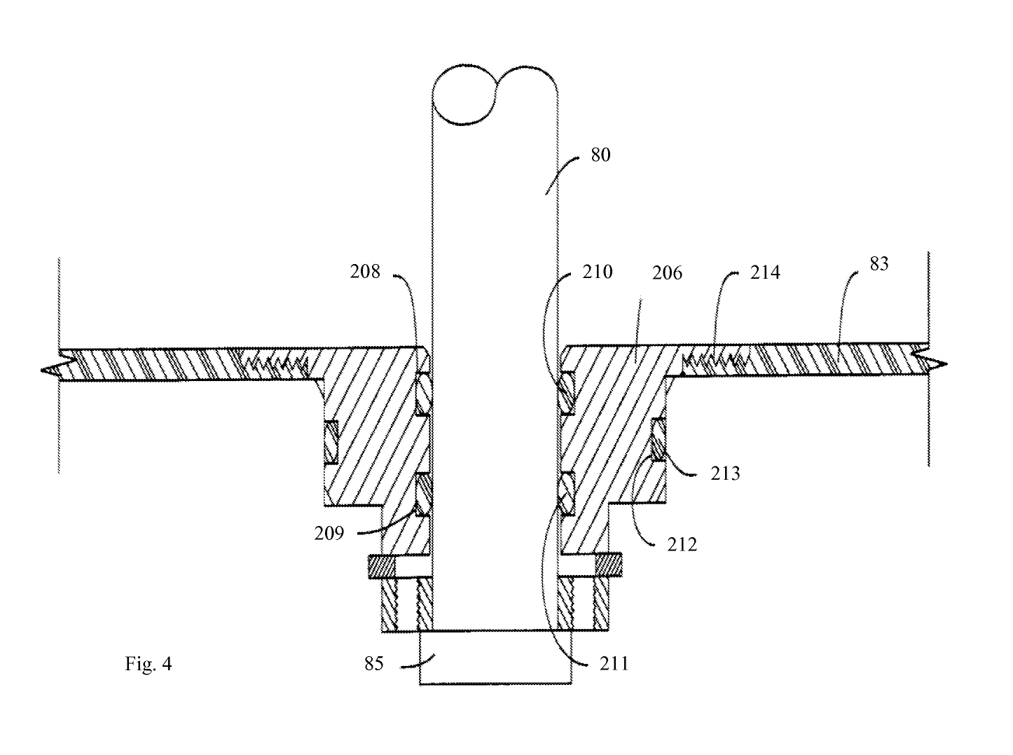

FIG. 4 is an alternative embodiment which employs a first sealing groove 208 and a second sealing groove 209 on the interior portion of the retainer housing 206. The first and second sealing grooves can have a first sealing ring 210 and a second sealing ring 211. A third sealing groove 212 may be located on the side of the retainer housing 206 away from the top shaft 80. Likewise, this third sealing groove 212 may have a third sealing ring 213. Also viewed in this embodiment, but applicable to other embodiments is a retainer housing serration 214. The serrations can be circular concentric teeth such that when they are bonded to the diaphragm 83, they can hold the diaphragm 83 from deforming in a tensioned circular manner.

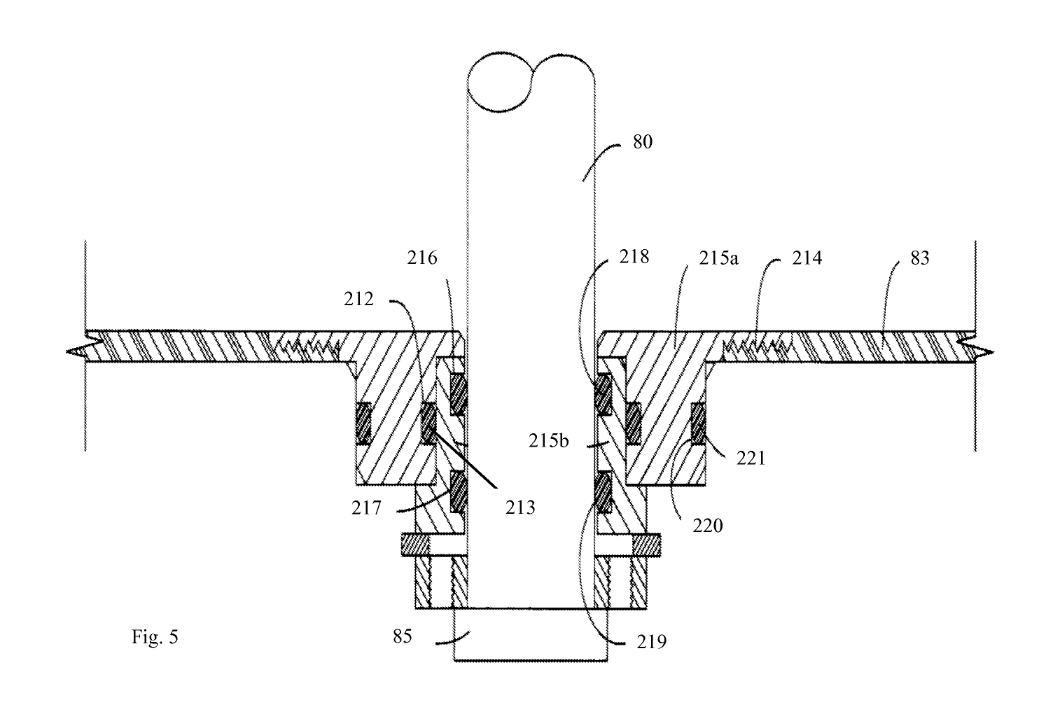

FIG. 5 is another embodiment of the invention having four sealing grooves disposed in a two part retainer housing 215a and 215b. More specifically, a distal sealing groove 216 and a proximal sealing groove 217 are depicted on portions of the one part of the two part retainer housing 215b. In the distal and proximal sealing grooves can be a distal seal 218 and a proximal seal 219 respectively, for sealing the top shaft 80. In a third sealing groove 212, also located on the first portion of the retainer housing 215a, can be third seal 213 which can be used to form a seal between the first portion of the retainer housing 215a and the second portion of the retainer housing 215b. In exterior sealing groove 220, located on the first portion of the retainer housing 215a, is an exterior seal 221 which can be used to form a seal between the first portion of the retainer housing 215a and the diaphragm retainer plate. Any of the seals can be an o-ring or a lip seal. In this Figure, serrations 214 are on the retainer housing 215a. These serrations can be teeth, circular, concentric teeth, such that when they are bonded, they hold the flexible diaphragm from deforming in a tensioned, circular manner.

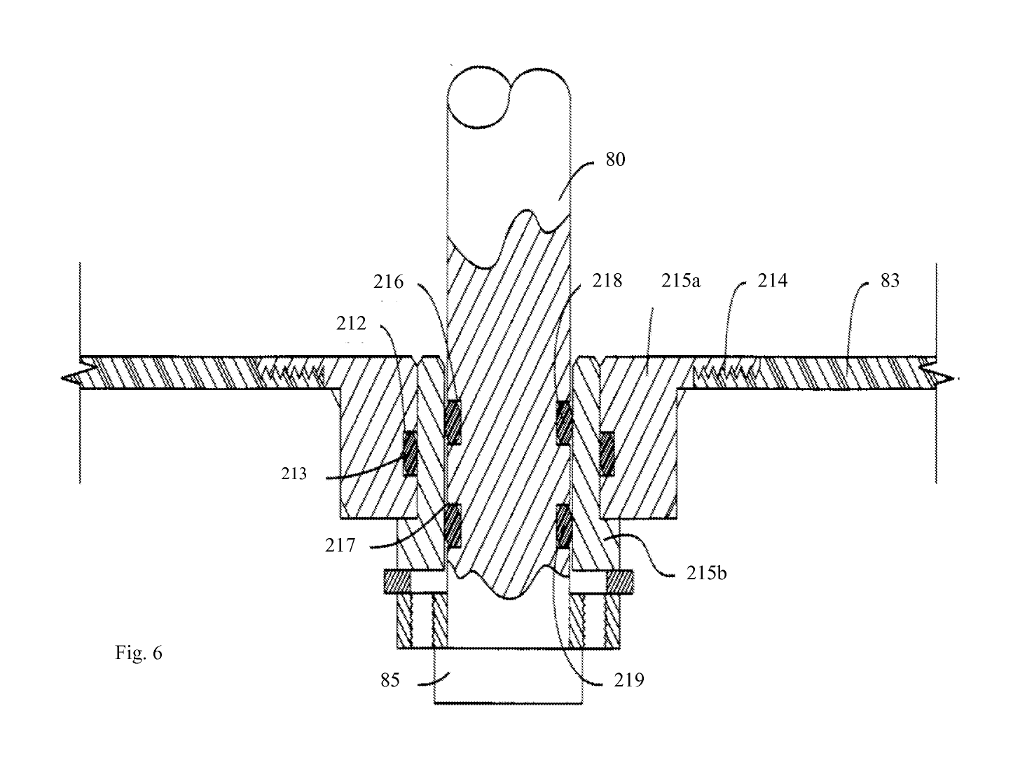

FIG. 6 depicts an alternative embodiment of FIG. 5, wherein the top shaft possesses the distal sealing groove 216 and the proximal sealing groove 217, rather than a portion of the retainer housing 215b. In a third sealing groove 212, also located on the first portion of the retainer housing 215a, can be third seal 213 which can be used to form a seal between the first portion of the retainer housing 215a and the second portion of the retainer housing 215b.

The foregoing detailed disclosure and description of the invention is illustrative and explanatory thereof, and it will be appreciated by those skilled in the art, that various changes in the size, shape and materials as well as in the details of the illustrated construction, reliability configurations, or combination of features of the various valve actuator elements of the present invention may be made without departing from the spirit of the invention.

1. A valve actuator with a top actuator housing connected to a lower actuator housing, for moving a valve gate, wherein the valve actuator moves the valve gate between an opened and a closed valve position within a valve body, and wherein the valve actuator comprises:
a. a pressure chamber and an inlet port formed in the top actuator housing;
b. a top shaft with a top shaft flange, wherein the top shaft extends through the top actuator housing;
c. a diaphragm retainer plate supporting the top shaft within the top actuator housing;
d. a diaphragm that applies pressure against the diaphragm retainer plate, and wherein the diaphragm further comprising a pressure side that engages the diaphragm retainer plate, and an atmospheric side opposite the pressure side, the diaphragm having a diaphragm ridge at least partially surrounding the top shaft;
e. a diaphragm retainer nut with a diaphragm retainer nut circular groove and at least partially surrounding the top shaft;
f. a keeper ring disposed around and supported by the top shaft flange;
g. a retainer ring disposed between the keeper ring and diaphragm retainer nut; and
wherein the diaphragm retainer nut groove is adapted to receive the diaphragm ridge.

2. The valve actuator of claim 1, wherein the diaphragm retainer nut is positioned substantially on the pressure side of the diaphragm and possesses a threaded interface at least partially surrounding the top shaft; the threaded interface being positioned on the atmospheric side of the diaphragm and threading into a diaphragm retainer plate nut to secure the diaphragm between the diaphragm retainer nut and the diaphragm retainer plate.

3. The valve actuator of claim 2, wherein upon threading the threaded interface of the diaphragm retainer nut into the diaphragm retainer plate nut, the diaphragm ridge is positioned within the diaphragm retainer nut circular groove.

4. The valve actuator of claim 3, wherein the diaphragm retainer nut has an inner diameter at least partially surrounding the top shaft and further comprises a sealing component spaced between the inner diameter of the diaphragm retainer nut and the top shaft.

5. The valve actuator of claim 4, wherein the sealing component comprises at least one o-ring.

6. The valve actuator of claim 1, wherein the pressure chamber is a pneumatic pressure chamber.

7. The valve actuator of claim 1, wherein the diaphragm ridge is made of stainless steel and molded to the diaphragm.

8. A diaphragm actuator with a top actuator housing connected to a lower actuator housing for moving a valve gate, and wherein the diaphragm actuator comprises:
a. a pressure chamber and an inlet port formed in the top actuator housing;
b. a top shaft with a top shaft flange, wherein the top shaft extends through the top actuator housing;
c. a diaphragm retainer plate supporting the top shaft within the top diaphragm housing;
d. a diaphragm that applies pressure against the diaphragm retainer plate, and wherein the diaphragm further comprising a pressure side that engages the diaphragm retainer plate, and an atmospheric side opposite the pressure side;
e. a retainer housing attached to the diaphragm;
f. a lip seal disposed within the retainer housing and at least partially surrounding the top shaft; and
g. a seal and rod wiper combination within the retainer housing and at least partially surrounding the top shaft.

9. The diaphragm actuator of claim 8, wherein the diaphragm is laminated with nylon on the atmospheric side.

10. The diaphragm actuator of claim 9, wherein the diaphragm is molded to the retainer housing.

11. The diaphragm actuator of claim 8, wherein the top shaft diameter can be varied depending on loading and stress conditions on the top shaft.

12. The diaphragm actuator of claim 8, wherein the retainer housing is adapted to have variable inner diameters to match out diameters of the top shaft.

13. The diaphragm actuator of claim 12, wherein the retainer housing is a two part retainer housing comprising an outer retainer housing and an inner retainer housing, the inner retainer housing being adjacent to the top shaft.

14. The diaphragm actuator of claim 13, further comprising a seal between the outer retainer housing and the inner retainer housing.

15. The diaphragm actuator of claim 13, wherein the inner retainer housing is capable of being replaced with another inner retainer housing greater or lesser in width.

16. The diaphragm actuator of claim 8, further comprising at one least sealing groove disposed in the retainer housing for supporting at least one seal.

17. The diaphragm actuator of claim 8, further comprising at least one sealing groove disposed within the top shaft for supporting at least one seal.

18. The diaphragm actuator of claim 8, further comprising a third sealing groove with a third seal between the retainer housing and the diaphragm retainer plate.

19. The diaphragm actuator of claim 8, wherein the retainer housing is made of stainless steel.

20. The diaphragm actuator of claim 8, wherein the pressure chamber is a pneumatic pressure chamber.
